(19) United States
(12) Patent Application Publication
(10) Pub. No.: US 2016/0011833 A1
(43) Pub. Date: Jan. 14, 2016

(54) METHOD AND APPARATUS FOR CONTROLLING WIRELESS PRINT COMMAND

(71) Applicant: Panasonic Intellectual Property Corporation of America, Torrance, CA (US)

(72) Inventor: Yuichiro Takayanagi, Rancho Palos Verdes, CA (US)

(21) Appl. No.: 14/726,497

(22) Filed: May 30, 2015

Related U.S. Application Data
(60) Provisional application No. 62/021,715, filed on Jul. 8, 2014.

(51) Int. Cl. G06F 3/12

(52) U.S. Cl. CPC G06F 3/1268; G06F 3/1292

(57) ABSTRACT

A printer apparatus receives a print request from a mobile station. The printer apparatus can perform a flush operation to delete the print request and the data associated with the print request in accordance with various terminate conditions.

### CROSS-REFERENCE TO RELATED APPLICATIONS

The present application claims the benefit of Provisional Application No. 62/021,715 filed on Jul. 8, 2014.

### TECHNICAL FIELD

The technical field relates generally to a printer apparatus and a mobile station and methods for operating both.

### BACKGROUND

In the past, printing operations were primarily done by sending a print request including one or more items desired to be printed (a print job) to a printer connected directly to a user apparatus (such as a desktop or laptop computer) via a USB connection or to a network printer shared by the user apparatus with other apparatuses via a LAN connection. In either case, software for the printer such as a printer driver usually had to be installed on the user apparatus in order to send the print request to the printer.

Recently, printers or printer servers are configured to accept print jobs from user apparatuses without requiring software drivers to be previously installed on the user apparatuses. If such a printer is on a wireless or wired network, a mobile user apparatus such as laptop computers, notepads, smartphones, etc. (referred to hereafter as “mobile stations”) can use services of such printers when accessing the network. For example, some printers may be connected to a printer server which is connected to a cloud server. The user apparatus can send a print job to a specific printer via the cloud server. In another example, a printer connected to an access point of a wireless network can be accessed by any mobile station on the wireless network. Such printers are more freely accessible by not only the owner of the printer, but by others having such mobile stations.

### SUMMARY

However, when a print job is sent to such printers, control of data in the print job is not maintained by the mobile station. Particularly, existing printers and associated systems accept print requests but do not provide the mobile station from which the print request originated the continued control over the print job. For example, if the printer does not implement the printing job immediately because of, for example, a lack of media such as paper or ink, or a heavy print queue, the print job may be implemented later after the user of the mobile station who originated the print job has left the location. If the data in the print job is confidential or private, the originator of the print job will likely prefer that the print job be canceled.

For this reason, it is more desirable for the mobile station to be able to continue controlling the print request after it is once issued, or to have a reliable way to cancel the print request in case the originator cannot stay to secure the printed material.

Accordingly, a mobile station according to various embodiments is configured to send a print request to a printer, and continue to control the print request until the print job is finished. Particularly, the mobile station is configured to be able to cancel the print request after the order is released to a printer.

According to one aspect, the mobile station is configured to generate a print request and to subsequently confirm the implementation of the print job once the printer's ability to immediately print is confirmed.

According to another aspect, the mobile station is configured to cancel the print request when the mobile station is more than a predetermined distance from the printer.

According to another aspect, the mobile station is configured to receive a notification when the print job is completed.

A printer apparatus or device according to various embodiments is configured to receive a print request from a mobile station and maintain a communication session with a mobile station until the print request is completed. The printer is configured to be able to cancel the print request upon receiving a cancel request from the mobile station.

According to one aspect, the printer is configured to receive and process a print request and to subsequently confirm whether the print request is still valid before completing the print request.

According to another aspect, the printer is configured to cancel the print request when the mobile station is more than a predetermined distance from the printer.

According to another aspect, the printer is configured to send a notification to the mobile station when the print job is completed.

### BRIEF DESCRIPTION OF THE DRAWINGS

The accompanying figures, in which like reference numerals refer to identical or functionally similar elements, together with the detailed description below are incorporated in and form part of the specification and serve to further illustrate various exemplary embodiments and explain various principles and advantages in accordance with the present invention.

FIGS. 1A-1C are schematic diagrams illustrating exemplary simplified and representative operating environments in which a mobile station communicates with a printer apparatus.

FIG. 2 is a block diagram of exemplary portions of a printer apparatus according to exemplary embodiments.

FIG. 3 is a block diagram of exemplary portions of a mobile station according to exemplary embodiments.

FIGS. 4A-4C are flow diagrams illustrating exemplary operations of the printer apparatus according to exemplary embodiments.

FIGS. 5A-5C are flow diagrams illustrating exemplary operations of the mobile station according to exemplary embodiments.

### DETAILED DESCRIPTION

In overview, the present disclosure concerns a mobile station such as, for example, a smart phone or a portable computer, and a printer apparatus such as an inkjet or laser printer or a device which generates media such as CD-ROM or a combination of a printer server and a printer. For simplicity, the various printer apparatus and/or printer servers will be referred to here as printing device or printer.

The present disclosure also concerns processors for the mobile station and printing device, memories associated with the processors, and computer readable instructions stored in the memories for configuring the processors. More particularly, various inventive concepts and principles are embodied in systems, apparatuses, and methods for configuring a mobile station to be able to request a print job at the printer to be canceled and to have the data of the print job deleted (Flush Print), and for configuring a printer to perform the Flush Print operation.

The instant disclosure is provided to further explain in an enabling fashion the best modes of performing one or more embodiments of the present invention. The use of relational terms such as first and second, top and bottom, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and the inventive principles, when implemented, are best supported with or in computer instructions (software) or integrated circuits (ICs), and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

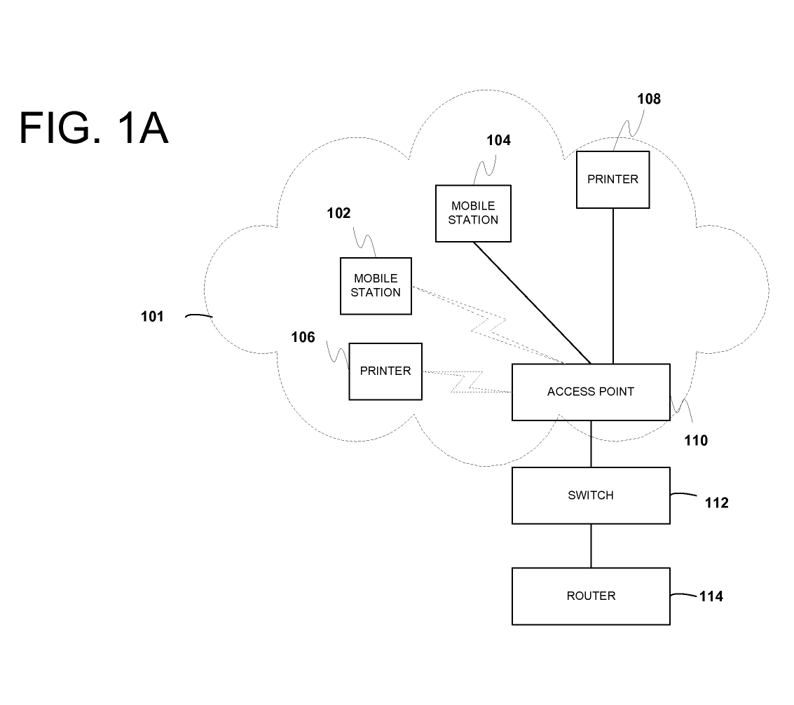

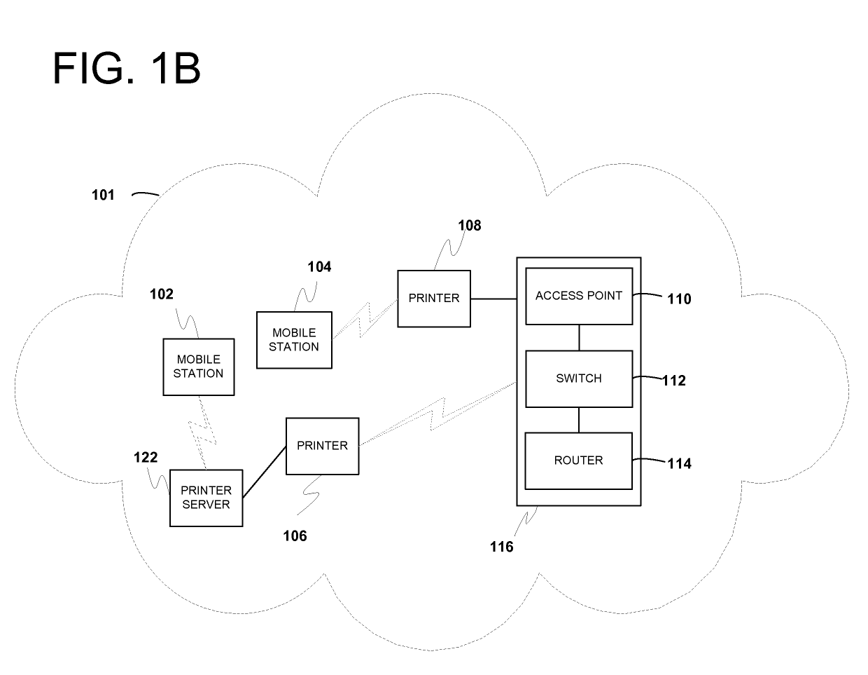

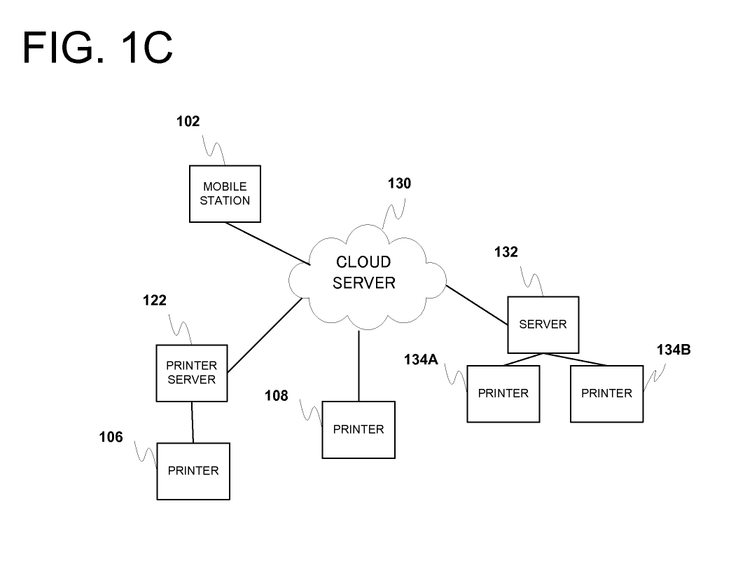

Referring to FIGS. 1A-1C, exemplary simplified and representative operating environments in which a mobile station can send a print request to a printing device according to a method, system or apparatus of various embodiments are shown. FIG. 1A shows an operating environment in which a wireless local area network (WLAN) 101 is provided by an access point (AP) 110 which in this case is a wireless hub connected to a switch 112 and a router 114. Although the switch 112 and router 114 are shown outside the WLAN in FIG. 1A and separate from the AP 110, the switch 112, router 114 and AP 110 may be portions of a single wireless router entity 116 which provides the WLAN 101 as shown in FIG. 1B. The WLAN 101 may be configured as described in IEEE Std. 802.11 (hereafter: “802.11 standard”), published on Mar. 29, 2012, the contents of which are incorporated by reference. Although referred to as a WLAN 101, mobile station 104 and printing device 108 can also be connected directly to the AP 110 via, for example, a LAN cable while mobile station 102 and printing device 106 are connected wirelessly to the AP 110. In other words, although referred to here as a WLAN 101, mobile stations and printers can still access the network via a wire. In WLAN 101, the mobile stations 102, 104 and the printers 106, 108 can communicate directly or indirectly via the AP 110 in a message format defined by 802.11 standard.

Alternatively, in another environment shown in FIG. 1B, the mobile station 104 and the printer 108 communicate directly. For example, the mobile station 104 and the printer 108 may both include Bluetooth capability. Further, the mobile station 102 can communicate with a printer server 122 which controls printer 106. Also, although not shown, the printer 108 itself can include an AP.

Other operating environments using similar technology or a combination thereof may also be used. For example, in FIG. 1C, the mobile station 102 can communicate via a cloud server 130 with the printing device 108, a printer server 122 controlling the printer 106, or a server 132 controlling printers 134A and 134B. Further, although not shown, the mobile station 102 can be connected to the printer 106, printer server 122 or cloud server 130 via a connection to the Internet which can of course be a wired or wireless connection.

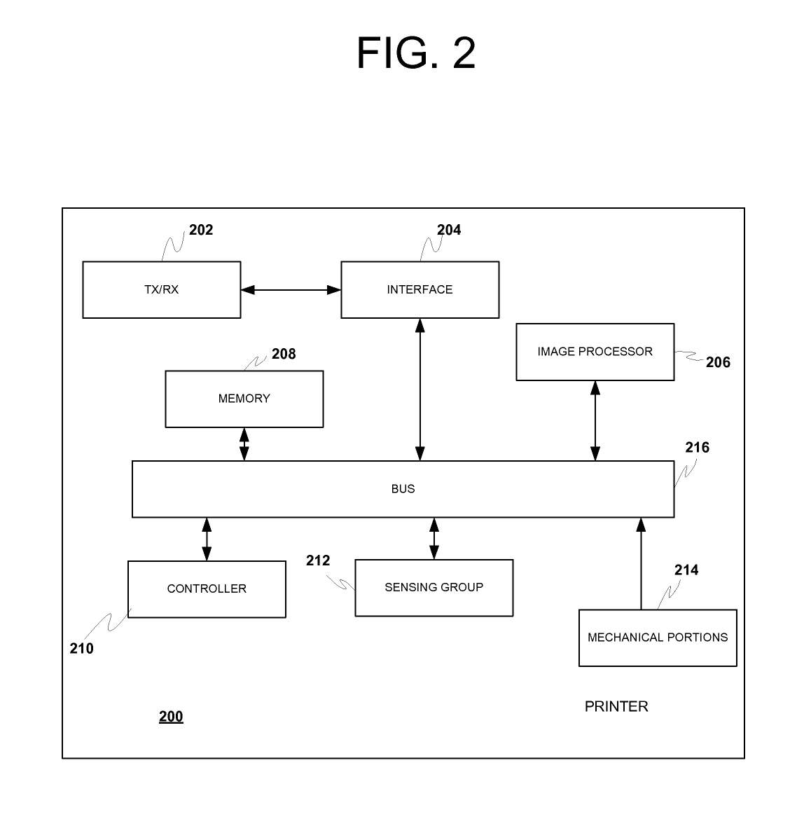

Referring to FIG. 2, portions of an exemplary printer 200 will be discussed. The printer 200 can include a transceiver 202, an interface 204, an image processor 206, a memory 208, a controller 210, a sensing group 212, a mechanical portion group 214 and a bus 216. Alternatively, the printer 200 can be a network printer coupled to a printer server in a master slave arrangement.

Referencing the Open Systems Interconnection reference model (OSI model), the transceiver 202 provides the physical layer functions such as modulating packet bits into electromagnetic waves to be transmitted and demodulating received waves into packet bits to be processed by higher layers. The transceiver 202 can include radio technology circuitry such as, for example, ZigBee, Bluetooth and WiFi. The transceiver 202 may also include Ethernet and a USB connection. Further, the transceiver 202 can include an antenna portion capable of receiving and transmitting the electromagnetic waves from and to, for example, an access point or the mobile station. The antenna portion can also be separate from the transceiver 202. The antenna portion can include, for example, an RF antenna, a coil antenna and/or a capacitive plate antenna.

The interface 204 can provide the data link layer and network layer functions of the printer 200 such as formatting the packet bits to an appropriate format for transmission by the transceiver 202 or received packet bits into an appropriate format for processing by the image processor 206 and the controller 210. For example, the interface 204 can be configured in accordance with the 802.11 media access control (MAC) protocol and the TCP/IP protocol. According to the MAC protocol, packet bits are encapsulated into frames for transmission and the encapsulation is removed from received frames. According to the TCP/IP protocol, error control is introduced and addressing is employed to ensure end-to-end delivery. Although shown separately here for simplicity, it should be noted that both the interface 204 and the transceiver 202 may be implemented by a network interface consisting of a few integrated circuits.

The sensing group 212 may include, for example, paper or media sensor and a carriage position sensor. The mechanical portion group 214 may include, for example, motor drivers for a paper feed motor, a carriage motor, and a print head driver for a printer head. Although not shown, the sensing group 212 and the mechanical portion group 214 may be connected to the bus 216 via an analog to digital converter.

The image processor 206 may be a conventional raster image processor.

The memory 208 can be one or a combination of a variety of types of memory or computer readable medium such as random access memory (RAM), read only memory (ROM), flash memory, dynamic RAM (DRAM) or the like. The memory 208 includes instructions for configuring the controller 210 as well as a basic operating system, executable code, and data and variables.

The controller 210 and the memory 208 can be part of a core (not shown). The sensor group 212, image processor 206, and interface 204, controller 210 and memory 208 can all be connected to a common bus 216.

The controller 210 is the main processing unit for interfacing with the other portions of the printer 200 via, for example, the bus 216. For example, the controller 210 can exchange data with the interface 204. The controller 210 can be configured by the instructions in the memory 208 to perform a print operation and processes related to the print operation, establish communication sessions for exchanging messages with other entities such as the mobile station, process messages received from such other entities, perform a flush print operation in which the print request and its data are deleted, etc. The messages may include print requests, requests for confirmations, confirmation notifications, requests to associate the printer with another device, an identification of the printer, etc. The messages are represented in the signals received and transmitted by the transceiver 202, but can be read at a higher level such as at the interface 204 or application executed by the controller 210.

The messages may be, for example, email messages. The transceiver 202 receives a wave signal which includes such an email message. The transceiver 202 demodulates the wave signal into packet bits. The interface 204 removes frame encapsulation from the packet bits. A high level application executed by controller 210 extracts the print request from the email message. In this case, the communication session is established upon receipt of the email message.

As mentioned above, the controller 210 can be configured to perform a flush print operation to delete the data associated with the print request if a terminate condition is met. Example terminate conditions will be discussed below.

The controller 210 is further configured by the instructions in the memory to generate and send a confirmation request to the mobile station in certain situations and to generate and send a notification message to the mobile station when the print job associated with the print request is completed.

The controller 210 can be a general purpose central processing unit (CPU) or an application specific integrated circuit (ASIC). For example, the controller can be implemented by a 32 bit microcontroller. For example, the controller 210 can be implemented by one of the MN103 Series (H, S and L) low power consumption, high performance microcomputers made by Panasonic. Of course the controller 210 is not limited to a 32 bit configuration.

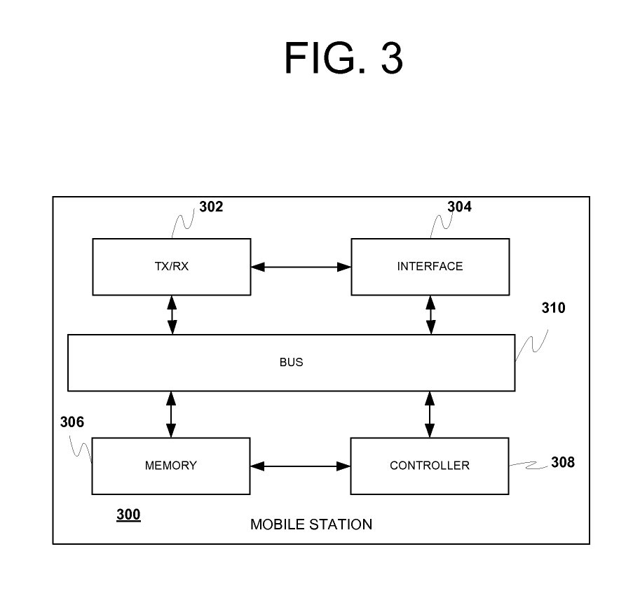

Referring to FIG. 3, portions of the mobile station 300 will be discussed. The mobile station 300 can include a transceiver 302, an interface 304, a memory 306, a controller 308 and a common bus 310.

The transceiver 302 can implement the receiving and transmitting functions of the mobile station 300. Alternatively, the mobile station 300 can include separate receiving and transmitting devices. The mobile station 300 sends and receives signals to and from other devices such as the printer or the access point. The signals may include signals representative of print requests, acknowledgements, etc., requests to associate the mobile station with a printer; an identification of the mobile station, etc. The transceiver 302 can include radio technology circuitry such as, for example, ZigBee, Bluetooth and WiFi. Further, the transceiver 302 can include an antenna portion capable of receiving and transmitting electromagnetic waves from and to the access point or a printer similar to that of the printer.

The interface 304 can provide the data link and network layer functions of the mobile station 300.

Similarly to the printer 200, the memory 306 can be one or a combination of a variety of types of memory or computer readable medium. The memory includes instructions for configuring the controller 308 as well as a basic operating system, executable code, and data and variables.

The controller 308 is the main processing unit for interfacing with the other portions of the mobile station 300 via the bus 310. For example, the controller 308 can exchange control signals and data with the interface 304 and store and retrieve data from the memory 300. The controller 308 can be configured by the instructions in the memory 306 to: perform a printing operation in which a communication session is established with a printer and a print request is generated and sent to the printer. Further, in the printing operation, the controller 308 can be configured to generate a flush command instructing the printer to delete the data associated with the print request if a terminate condition is met. Examples of terminate conditions are discussed below.

The controller 308 is further configured by the instructions in the memory 306 to generate and send an acknowledgment message to the printer in certain situations and to receive a notification message from the printer when the print job associated with the print request is completed.

The controller 308 can be a general purpose central processing unit (CPU) or an application specific integrated circuit (ASIC). The memory 306 and controller 308 can be part of the ASIC 310. For example, if the mobile station 300 is a smartphone, the controller 308, memory 306, bus 310 and interface 304 will likely be integrated onto a single chip set, referred to as a system on chip (SoC), including a quad-core or dual-core CPU.

It should be noted that the controllers for both the mobile station 300 and printer 200 can be configured to generate messages according to the format of the wireless networks such as, for example, 802.11 protocol or Bluetooth.

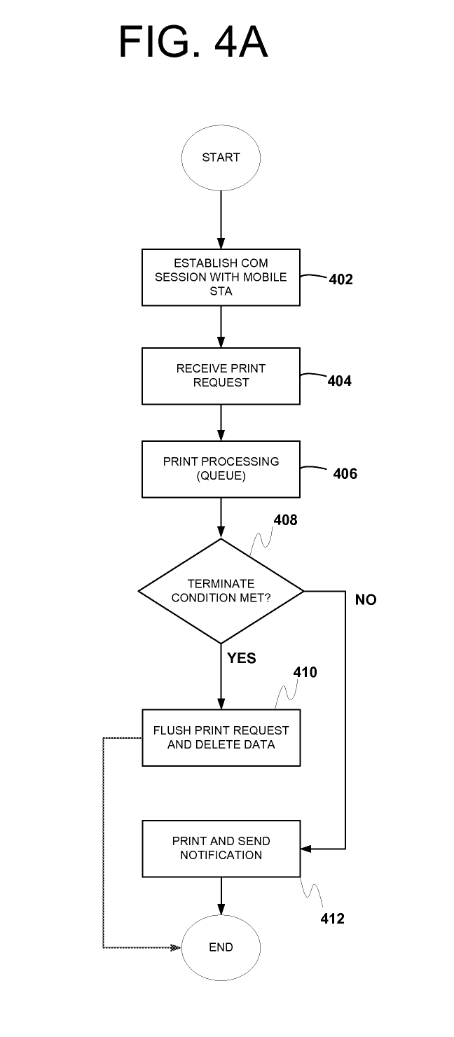

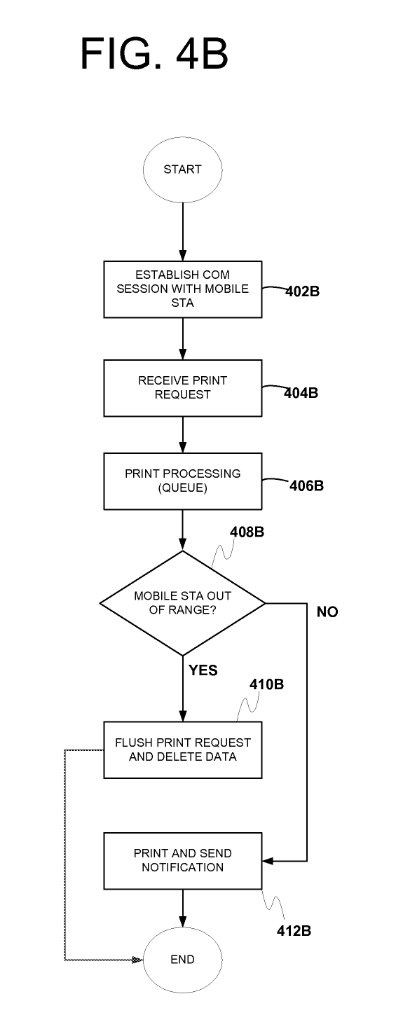

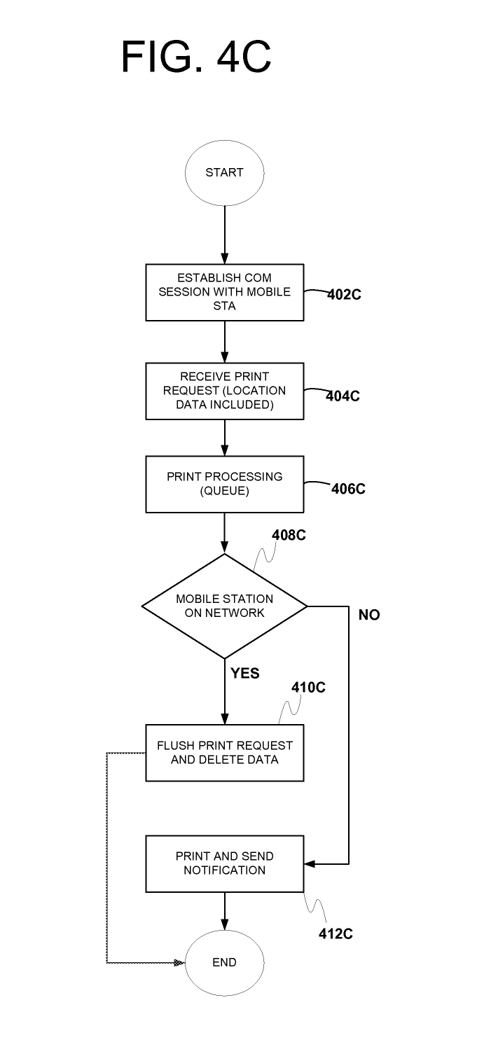

Referring to the flow diagram illustrated in FIG. 4A, operations performed by portions of the printer 200 will be discussed. Initially, a communication session can be established between the printer 200 and the mobile station 300 at 402. The communication session broadly refers to a channel of communication established between the mobile station 300 and the printer 200. For example, in a case in which the mobile station 300 establishes a connection with a wireless network common to the printer (such as WLAN 101 shown in FIG. 1A), first the mobile station 300 can receive a beacon signal from the AP via passive monitoring or in response to a probe request. The mobile station 300 stores a service set identifier (SSID) contained in the beacon signal in the memory. Wireless connection is established via the transceiver. The mobile station 300 may receive information indicating the printer 200 as a printer available unilaterally or in response to a probe request to all stations on the AP. If the mobile station 300 accepts the printer 200, a communication session with the printer is established. In another case, a communication session can be established by a virtual terminal protocol application such as TELNET for sending and receiving packets in accordance with transmission control protocol (TCP). Other options for Establishing Communication session include: direct-link setup (DLS) and Tunneled direct-link setup (TDLS) according to 802.11 protocol. Establishing the communication session may include an authentication process being performed between the mobile station 300 and the printer 200 such as issuance of a security key.

At 404, the printer receives a message including the print request sent by the mobile station. For example, the message may be an email message including an item to be printed as an attachment or an 802.11 MAC frame including the print request as packet bits. The message can also be a short message service (SMS) message, Bluetooth message, near field communication (NFC) message, etc. The print request can include location and time data such as GPS data inserted by a higher level application or location data which is stored in the frames according to TCP/IP. The print request may further include time limit data specifying a certain time by which the print request must be executed.

At 406, the printer performs conventional processing to process the print job, and/or places it in a queue if other higher priority print jobs are being handled.

At 408, prior to performing the print job, the printer determines if one or more terminate conditions predetermined or specified in the print request are satisfied. Specific exemplary terminate conditions will be discussed later.

If one or more of the terminate conditions have occurred (YES at 408), at 410 the printer performs a flush operation in which the print request and all data of the print job are deleted. Optionally, here the controller can generate a notification message to be sent to the mobile station notifying that the print request was flushed. If one or more of the terminate conditions have not occurred (NO at 408), at 412 the printer performs the print job and sends a notification message to the mobile station via the communication session indicating that the print job was successfully executed.

Referring to FIG. 4B, operation of the printer with regards to a terminate condition of whether or not the mobile station is more than a predetermined distance from the printer will be discussed. After or when the communication session is established on 402, the printer receives continuous or intermittent location data from the mobile station in a print request at 404. The location data can be the location data in the MAC IEEE 802.11 frames or GPS data attached to the message at a higher level application.

At 406, the printer performs conventional processing to process the print job, and/or places it in a queue if other higher priority jobs are being handled. Processing the print job can include generating print media in accordance with the print job such as a CD or DVD-ROM, printing the data of the print job on paper media, etc.

At 408, prior to performing the print job, the printer determines if the mobile device is more than a predetermined distance from the printer (out of range). For example, if the location data is in the MAC IEEE 802.11 frames, the controller of the printer can determine if the location is greater than a predetermined distance from the printer. For example, the predetermined distance can be 25 m. The location data can be determined by comparing GPS coordinates of the mobile station to those of the printer device. The location data can be received from continuous or intermittent data communicated with the printer during the communication session. Alternatively, the printer can request the mobile station to send another message including recent GPS data. If it is determined that the mobile station is out of range (YES at 408), at 410 the printer performs the flush operation in which the print request and all data of the print job are deleted. Optionally, here the controller can generate a notification message to be sent to the mobile station notifying that the print request was flushed.

If it is determined that the mobile station is not out of range (NO at 408), at 412 the printer performs the print job and sends a notification message to the mobile station via the communication session indicating that the print job was successfully executed.

Referring to FIG. 4C, operation of the printer with regards to a terminate condition of whether or not the mobile station has left the network will be discussed. At 408, prior to performing the print job, the printer determines if the mobile device has left the network. For example, if the network is an 802.11 standard network provided by an AP as in FIG. 1A, the printer can receive information from the AP indicating all mobile stations currently allocated network resources such as Ethernet or MAC addresses. When a mobile station establishes a wireless connection with an AP (or hub), it gives the mobile station a temporary address and broadcasts this temporary address to all stations on the wireless network. The hub can determine that the mobile station has left and send a new update of addresses. The printer or printer server knows that the mobile station has left the network (or the area). This information can be used to determine if the mobile station has left the network. Alternatively, the printer can determine that the mobile station has left the network if an attempt to send a message to the mobile station over the communication session fails.

If it is determined that the mobile station has left the network (YES at 408), at 410 the printer performs the flush operation in which the print request and all data of the print job was deleted. A notification message such as an email message can be sent to the mobile station indicating that the print request was flushed.

If it is determined that the mobile station is still on the network (NO at 408), at 412 the printer performs the print job and sends a notification message to the mobile station via the communication session indicating that the print job was successfully executed.

Alternative terminate conditions such as a cancel request received from the mobile station, exceeding a specified time limit, or a failure to receiving a confirmation message can also be used as the terminate condition. For example, the printer can perform the flush operation at 408 if the cancel request is received from the mobile station via the communication session, if due to the size of the print queue or other problems such as lack of print media, the print job has not been executed before a time limit specified in the print request or set in advance, or if the printer fails to receive a confirmation message from the mobile station. Particularly, the printer can send a request for a confirmation message to confirm that the mobile station still desires the print job to be executed if it has not been executed within the time limit. Further, a combination of the above exemplary terminate conditions may be used.

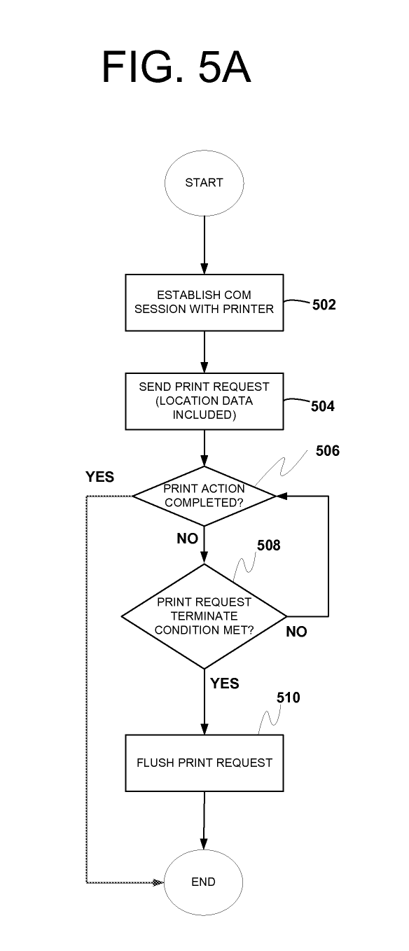

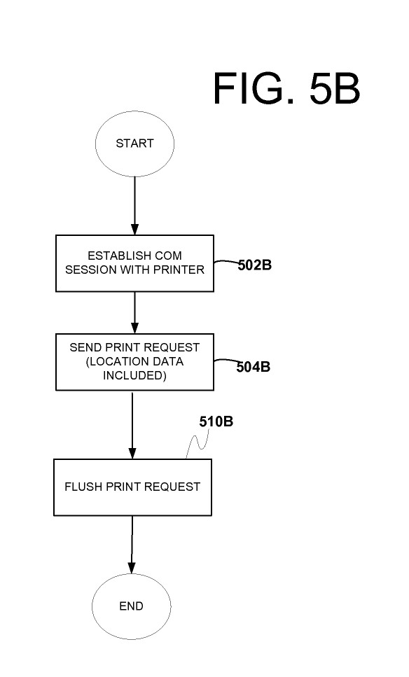

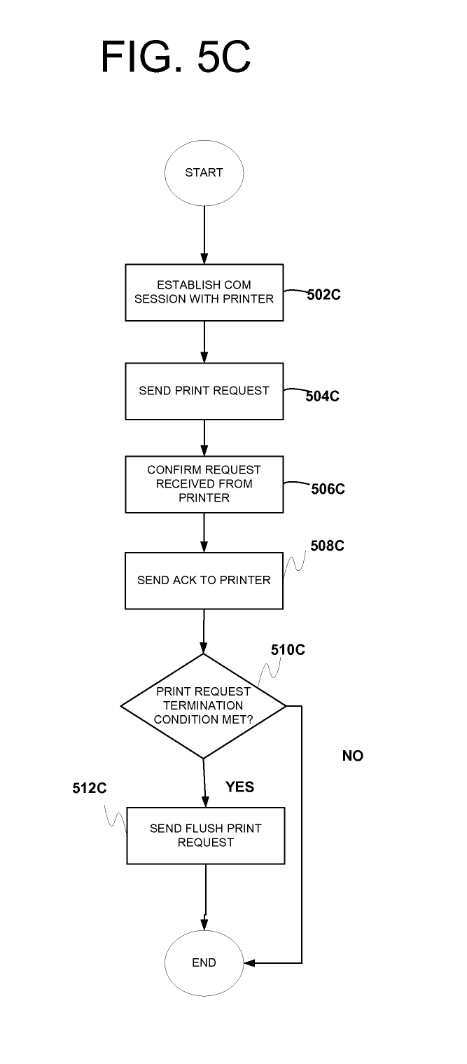

Referring to the flow diagram illustrated in FIG. 5A, operations performed by portions of the mobile station will be discussed. At 502, a communication session is initially established between the printer and the mobile station as discussed above. At 504, the mobile station sends a print request to the printer. The print request can include the data requested to be printed and, for example, location data and time limit data.

At 506, the mobile station determines if the print job has been executed by, for example, checking if a notification message has been received. If the printer has other print jobs being handled, the print request may be placed in a queue. If the print job has been executed (YES at 506), the routine ends. When the print job is successfully printed, the mobile station can receive a notification message from the printer via the communication session.

If the print job has not been executed (NO at 506) because, for example, it is in the queue or still being processed, at 508 the mobile station determines if a print request terminate condition has been satisfied. If the terminate condition has not been satisfied (NO at 508), the routine returns to 506. The terminate condition may be: (1) the mobile station is more than a predetermined distance from the printing device; or (2) failure to receive a notification indicative of completion of the print job in more than a predetermined period of time from sending the message including the print request.

If the terminate condition has been satisfied (YES at 508), at 510 the mobile station can send a request to the printer to terminate the print job and delete the data (Flush print request).

Referring to the flow diagram of FIG. 5B, a terminate condition can be whether or not the mobile station has sent a Flush request. Alternatively, the terminate condition can be whether the mobile station is more than a predetermined distance from the printer or whether the mobile station has left the network.

As shown in FIG. 5C, the mobile station can receive a confirmation message from the printer informing the mobile station that the print request was successfully received. The mobile station can then send an acknowledgment to the printer before the print job is actually processed to confirm that the print job is still desired.

The mobile station can include a user interface for communicating the confirmation message and/or prompts from the printer. The user interface can be a display showing a pop-up alert or color to communicate the confirmation message. The user interface can also include a vibration or motor movement to indicate the confirmation message.

Other embodiments will be apparent to those skilled in the art from consideration of the specification and practice of the invention disclosed herein. It is intended that the specification and examples be considered as exemplary only, with a true scope and spirit of the invention being indicated by the following claims.

1. A method of executing a print job at a printing device capable of exchanging messages with a mobile station, comprising:
receiving a message including a print request including data for a print job from the mobile station;
determining if a predetermined terminate condition is met prior to performing the print job; and
deleting the data for the print job if the predetermined terminate condition is satisfied.

2. The method of claim 1, wherein the predetermined terminate condition is reception of information indicating that the mobile station is more than a predetermined distance from the printing device.

3. The method of claim 2,
wherein the mobile station and the printing device are connected to a common communication network when the printing device receives the message including the print request,
wherein the predetermined terminate condition is an indication that the mobile station is no longer connected to the communication network.

4. The method of claim 1, wherein the predetermined terminate condition is failure to receive a confirmation message within a predetermined period of time.

5. The method of claim 1, wherein the predetermined terminate condition is reception of a cancel request associated with the mobile station or a determination that the printer cannot execute the print job prior within a predetermined period of time from when the print request was received, further comprising:
sending a notification message to the mobile station indicating whether the print job was executed.

6. The method of claim 1, wherein:
receiving of the message occurs during an active communication session with the mobile station, and
the determining of the predetermined cancel condition is failure to receive a confirmation message associated with the mobile station within a predetermined period of time from receiving the print request.

7. The method of claim 1,
wherein the message is an email message with an email address associated with the mobile station as a source address and an email address associated with the printing device as a destination address,
wherein the predetermined terminate condition is failure to receive another email message with the email address of the mobile station as the source address confirming the print request when more than a predetermined amount of time has passed from reception of the email message.

8. The method of claim 1,
wherein the printer device and the mobile station are connected to a common 802. 11 standard wireless local area network (WLAN),
wherein the message received from the mobile station includes address information in accordance with the 802.11 MAC or TCP/IP standards,
wherein the exchange of messages occurs either directly between the printer device and the mobile station or indirectly via an access point of the WLAN, and
wherein the predetermined terminate condition is one of the mobile station no longer connected to the common WLAN.

9. A method of controlling a print command at a printing device by a mobile station, comprising:
sending a message including a print request including data for a print job to the printing device;
sending a message including a print confirmation to the printing device to confirm the print request according to a first predetermined condition; and
sending a message indicative of a request to cancel the print request and delete the data of the print job according to a second predetermined condition.

10. The method of claim 9, wherein the first predetermined condition is receiving a request for print confirmation from the printing device.

11. The method of claim 9, wherein the second predetermined condition is one of: (1) the mobile station is more than a predetermined distance from the printing device; and (2) failure to receive a notification indicative of completion of the print job in more than a predetermined period of time from sending the message including the print request.

12. The method of claim 9, further comprising:
establishing an active communication session with the printing device,
wherein the messages including the print request and the print confirmation are sent during the active communication session.

13. The method of claim 1,
wherein the message including the print request is an email messages with an email address of the mobile station as the source address and an email address of the printing device as the destination address.

14. A printing control device comprising:
a transceiver for sending and receiving signals representative of messages, the messages including a print request including data for a print job associated with a mobile station;
an interface portion for adding or removing formatting information to the messages according to one or more protocols;
a memory portion;
a controller configured according to the memory portion to:
determine if a predetermined terminate condition associated with the print request is satisfied prior to causing the print job to be executed; and
delete the data for the print job if the predetermined condition is satisfied.

15. The printing control device of claim 14, wherein the predetermined cancel condition is reception of information indicative that the mobile station is more than a predetermined distance from the printing device.

16. The printing control device of claim 14, wherein the predetermined cancel condition is reception of information indicative that the mobile station is no longer connected to a communication network common with the printing control device.

17. The printing control device of claim 14, wherein
the control device is further configured to establish an active communication session with the mobile station according to a predetermined protocol and the message including the print job received during the active communication session.

18. The printing control device of claim 14, wherein
the message including the print request job is an email message having a source address associated with the mobile station and a destination associated with the printing control device,
the predetermined cancel condition includes failure to receive a confirmation message having the source address within a predetermined period of time, the confirmation message indicative of a continued desire to have the print request job executed, and
the controller is further configured to generate another email message to be sent to the source address, the another email message including a notification of completion of the print job or of cancellation of the print request.

19. The printing control device of claim 14, wherein the transceiver and interface portion are configured in accordance with the IEEE 802.11 standard for wireless local area networks.

20. The method of claim 2, wherein the information indicating that the mobile station is more than a predetermined distance from the printing device is GPS coordinate information.

21. A printing device comprising:
a transceiver for sending and receiving signals representative of messages, the messages including a print request message including data for a print job associated with a mobile station;
an interface portion for adding or removing formatting information to the messages according to one or more protocols;
a memory portion;
a controller configured according to the memory portion to:
determine if a predetermined terminate condition associated with the print request is satisfied;
delete the data for the print job if the predetermined condition is satisfied; and
generate print media in accordance with the print request message if the predetermined condition is not satisfied.

22. The printing device of claim 21, wherein the predetermined terminate condition is reception of information indicating that the mobile station is more than a predetermined distance from the printing device.

23. The printing device of claim 22,
wherein the printing device is connected to a common communication network common with the mobile station when the printing device receives the message including the print request, and
wherein the predetermined terminate condition is an indication that the mobile station is no longer connected to the communication network.

24. The printing device of claim 21, wherein the predetermined terminate condition is failure to receive a confirmation message from the mobile station within a predetermined period of time.

25. The printing device of claim 21, wherein:
the predetermined terminate condition is reception of a cancel request associated with the mobile station or a determination that the printer cannot execute the print job prior within a predetermined period of time from when the print request was received; and
the controller is further configured to generate a notification message to be sent to the mobile station, the notification message indicating whether the print job was executed.
